(19) United States
(12) Patent Application Publication
(10) Pub. No.: US 2009/0113333 A1
(43) Pub. Date: Apr. 30, 2009

(54) Extendable Toolbar for Navigation and Execution of Operational Functions

(75) Inventors: Richard Dellinger, San Jose, CA (US); Matthew W. Crowley, Los Altos, CA (US); Jeffrey Finkelstein, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: PALM, INC., Sunnyvale, CA (US)

(21) Appl. No.: 11/925,669

(22) Filed: Oct. 26, 2007

(51) Int. Cl. G06F 3/048

(52) U.S. Cl. 715/771

(57) ABSTRACT

A navigation and execution mechanism for a computing device includes a navigation interface and a toolbar. The navigation mechanism includes a center selectable switch bounded by first and second selectable switches opposite each other and third and fourth selectable switches opposite each other and adjacent to the first and the second selectable switches. The toolbar is displayed on a screen of the computing device in response to execution of an application within the computing device. The toolbar is configured to display a set of operations corresponding to the application, the toolbar further configured to execute a first operation in response to triggering the center selectable switch, a second operation in response to triggering the first selectable switch, a third operation in response to triggering the second selectable switch. Further, the toolbar is extendable to include two additional toolbars accessible directly through the a single action of the navigation mechanism.

### BACKGROUND

1. Field of Art

The disclosure generally relates to the field of control mechanisms, and more particularly, to an extendable toolbar for navigation and execution of operational functions.

2. Description of the Related Art

As portable computing devices, including mobile telephones and media players, become more advanced there is a desire to increase the number of mechanical interfaces on the device to allow for rapid access to commonly used functions. The increase in mechanical interfaces increases the cognitive load on the user. For example, on devices that allow execution of multiple applications, each application may use the same set of mechanical interfaces. However, the consistency of how those mechanical interfaces map to a particular application in a device often varies. Thus, the user is forced to discern what function each mechanical interface corresponds to for each different application the device.

Similarly, the amount of available space on many portable devices is decreasing as users demand greater portability. However, the need for advanced interactions with such devices has not subsided. Thus, while devices have become smaller in size, the amount of available space for mechanical interfaces is decreasing as other elements such as screens increase in size thereby taking away space from other areas.

Likewise in an effort to move some interfaces to on-screen, portable devices are now facing increasing challenges of a lack of screen space to display the full range of functions users often desire. For example, media applications typically have functions that include play, pause, forward, reverse, skip forward, skip backward, volume control, bass control, and the like. However, the device constraints often lead to providing only a subset of the functionality, e.g., only the play, pause, forward, and reverse functions, is provided on screen while other functions are dedicated to the mechanical device, e.g., volume and bass controls. If there is access to the functionality within the device as an on-screen mechanism the controls are not uniform across applications. Moreover, the controls available at the system level are not particularly tunable for specific applications so that any change at the system level is applied uniformly to all applications.

Thus, conventional systems lack a mechanism for an extendable toolbar system for navigation and execution of functional operations. Moreover, conventional systems lack a system level controls toolbar that applies uniformly across a group of related applications.

### SUMMARY

One embodiment of a disclosed navigation and execution mechanism is for integration with a computing device. The mechanism includes a navigation interface and at least one toolbar. In one embodiment, the navigation mechanism includes a center selectable switch bounded by a first and a second selectable switches that are opposite each other and a third and fourth selectable switches that also are opposite each other and adjacent to the first and second selectable switches. By way of example, the first and the second selectable switches may be left and right selectable switches and the third and the fourth selectable switches may be up and down selectable switches.

The toolbar is displayed on a screen of the computing device in response to execution of an application within the computing device. The toolbar configured to display a set of operations, the toolbar further configured to execute a first operation in response to triggering the center selectable switch, a second operation in response to triggering the left selectable switch, and a third operation in response to triggering the right selectable switch.

Further, the toolbar may include other functions associated with the application. These other functions are directly, and immediately, accessible through a single action interaction with the initially displayed toolbar and navigation mechanism as another toolbar. Specifically, a second toolbar having a second set of triggerable operations may be displayed in response to triggering the third selectable switch. Once displayed, the toolbar is configured to execute a first operation in response to triggering the center selectable switch, a second operation in response to triggering the first selectable switch, and a third operation in response to triggering the second selectable switch. Further, from the first toolbar, the mechanism can be configured to directly, and immediately, access a third toolbar having a third set of triggerable operations through a single action of triggering the fourth selectable switch. Once displayed, the toolbar is configured to execute a first operation in response to triggering the center selectable switch, a second operation in response to triggering the first selectable switch, a third operation in response to triggering the second selectable switch

In one embodiment, the toolbar mechanism is configured to be stored as a template in a system level database with core control functions also mapped at the system level. For example, the template for media related applications such as audio players, video players, and image viewers, may be stored with control data corresponding to operations such as play, pause, forward, reverse as well as volume control, base control, and the like. Further, these controls may be accessible by other applications that use similar functions, such as a phone application within a mobile computing device such as a smartphone. Thus, applications are advantageously offloaded from having to integrate such controls, which helps reduce overall application size and complexity. Moreover, by calling such functions from a system level, the overall look, feel and operation is consistent across a number of applications. In still other embodiments, the base template can be extended by an application and saved either at the system level or within the application.

Another advantage of the mechanism is that the operational commands within the toolbar are grouped together as a set of toolbars in which a subset of those operational toolbars and functions is displayed at any one time with the others immediately made available with one additional step on a navigation mechanism. Hence, one navigation mechanism can control a number of functions and be available to the user through that single navigation mechanism interface. Thus, the user beneficially is able to get at multiple functions immediately without having to traverse through menus or interacting with a large number of interface mechanisms on the device or within the software of the device.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the detailed description, the appended claims, and the accompanying drawings, in which:

FIG. 1 illustrates one embodiment of a mobile computing device.

FIG. 2 illustrates one embodiment of an architecture of a mobile computing device.

FIGS. 3a to 3c illustrates one embodiment of toolbar configuration for a mobile computing device.

FIGS. 4a to 4c illustrate an example toolbar configuration for a first media application executing on a computing device.

FIGS. 5a to 5b illustrate an example toolbar configuration for a second media application executing on a computing device.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### EXAMPLE MOBILE COMPUTING DEVICE

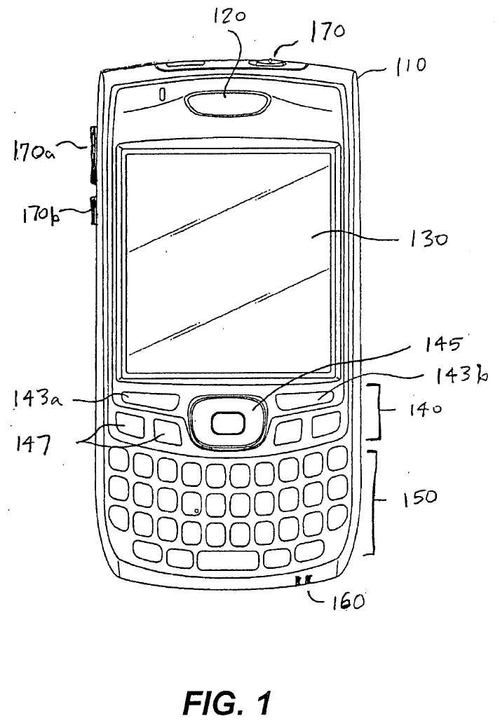

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 12.75 centimeters in width, 0.64 to 2.2 centimeters in height and weigh between 55 and 230 grams.

The mobile computing device 110 includes a speaker 120, a screen 130, a navigation area 140, a keypad area 150, and a microphone 160. The mobile computing device 110 also may include one or more switches 170, 170a, 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 320×320, or a 320×480 transflective display. In alternative embodiments, the aspect ratios and resolution may be different without departing from the principles of the inventive features disclosed within the description. By way of example, embodiments of the screen 130 may comprise an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitative), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. In one example embodiment, the navigation switch 145 comprises a perimeter over selectable switches with substantially each side of the perimeter being selectable to triggers a switch close to it and a center portion that also is selectable to trigger switch below it. The switches may be positioned so that there are two switches along each end of an x-axis and two switches on either end of y-axis. With some applications and functions, the center switch when triggered executes a function or command. The switches around it in such applications allow for movement in a left or right (x-axis) or up or down (y-axis) direction or jump between selectable entities on a user interface (e.g., jump between links, tabs or boxes). Note that this configuration may sometimes be referenced as a five-way navigation mechanism. Also, it is noted that in some embodiments depressing and holding the center button for at least a predetermined period of time may signal the system to perform a function associated with such switch and defined activity.

In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards), which may include memory cards such as CompactFlash™ cards, SD cards, XD cards, Memory Sticks™, MultiMediaCard™, SDIO, and the like.

### EXAMPLE MOBILE COMPUTING DEVICE ARCHITECTURAL OVERVIEW

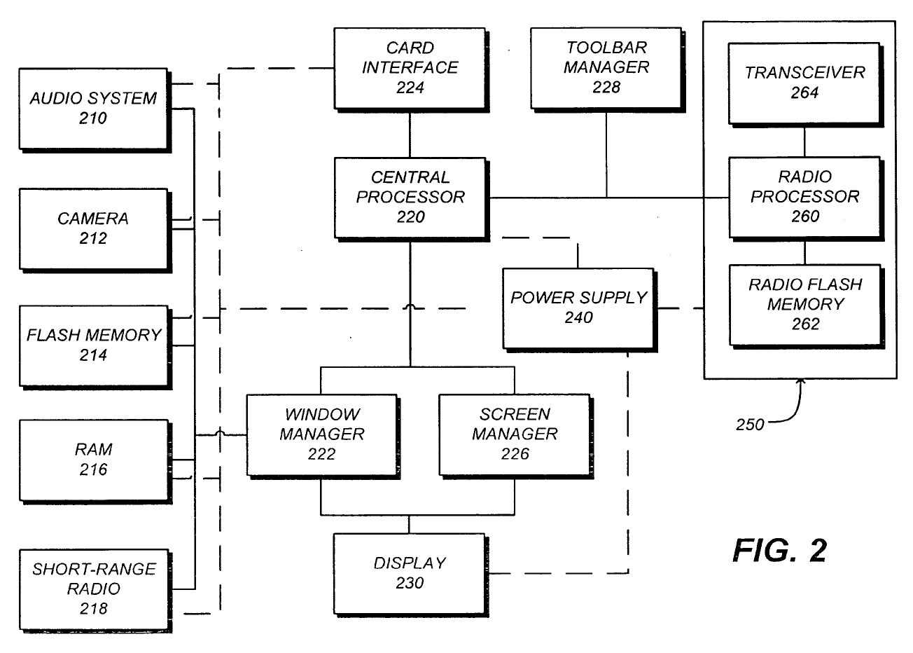

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, RAM memory 216, short range radio module 218 (e.g., Bluetooth, Wireless Fidelity (WiFi) component), a window manager (or module) 222, a screen manager (or module) 226, and a toolbar manager (or module) 228. The power supply 240 powers the central processor 220, the radio subsystem 250 and a display driver 230 (which may be contact- or inductive-sensitive). The power supply 240 may correspond to a battery pack (e.g., rechargeable) or a powerline connection or component.

In one embodiment, the window manager 222 comprises a software or firmware process that initializes a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to modify a window, such as resizing the window, moving the window or any other command altering the appearance or position of the window, and modifies the window accordingly.

The screen manager 226 comprises a software or firmware process that manages content displayed on the screen 130. In one embodiment, the screen manager 226 monitors and controls the physical location of data displayed on the screen 130 and which data is displayed on the screen 130. The screen manager 226 alters or updates the location of data on the screen 130 responsive to input from the central processor 220, to modify the screen 130 appearance. In one embodiment, the screen manager 226 also monitors and controls screen brightness and transmits control signals to the central processor 220 to modify screen brightness and power usage to the screen 130.

In one embodiment, the toolbar manager 228 is configured to manage toolbar configurations at a system level for use by applications executing within the device 110. The toolbar manager 228 is configured to display triggerable functions (e.g., functions that a user may seek to execute) and when those functions are triggered notifying the processor 220 that such function has been triggered. The toolbar manager also is configured to provide a grouping of toolbars corresponding to a particular application. Each toolbar is accessible through a single action of a navigation mechanism, for example, the navigation mechanism 145, a software version of the navigation ring 145 (e.g., a navigation mechanism configuration on a touch sensitive panel). The toolbar manager 228 configuration and operation is further described within.

It is noted that the toolbar manager 228 includes an application programming interface (API). An application may be configured to call the toolbar for use within the application when the application is being executed by processor 220. This configuration eliminates the need for the application to incorporate its own toolbar into its structure. In turn, this saves developers development resources that would otherwise be necessary to integrate such toolbar into the application. The configuration also reduces overall application size saving resources such as storage (both short term, e.g., RAM, and longer term, e.g., flash memory) resources due to the elimination of code necessary for a full toolbar. Further, the use of a system level toolbars allows for a uniform presentation of toolbars and functions triggerable (execution of function) by the toolbar.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile, High Speed Download Packet Access (HSDPA), High Speed Uplink Packet Access (HSUPA) and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a serial line 278.

The card interface 224 is adapted to communicate with the expansion slot expansion slot 125. The card interface 224 transmits data and/or instructions between the central processor and an expansion card or media card included in the expansion slot 125. The card interface 224 also transmits control signals from the central processor 220 to the expansion slot 125 to configure an expansion card or media card included in the expansion slot 125.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

### EXAMPLE TOOLBAR CONFIGURATIONS

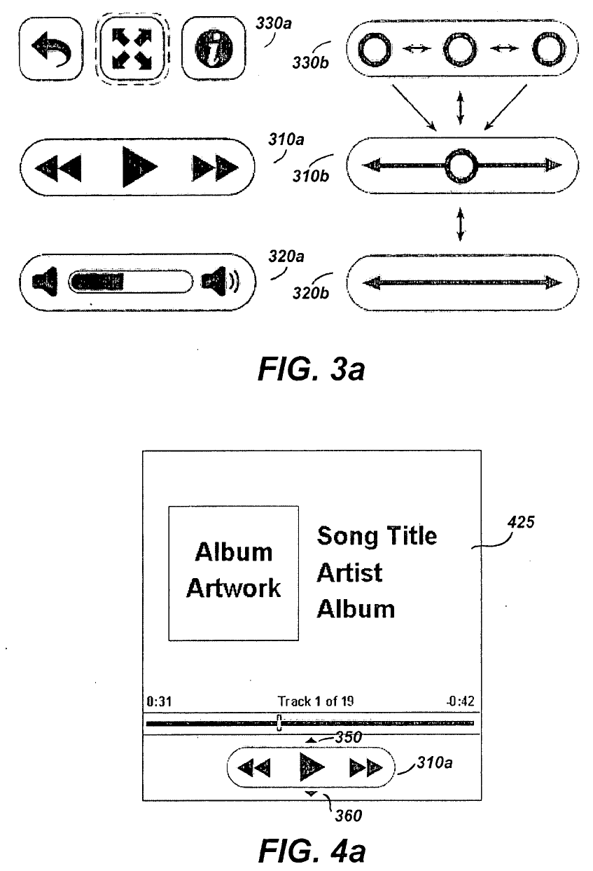

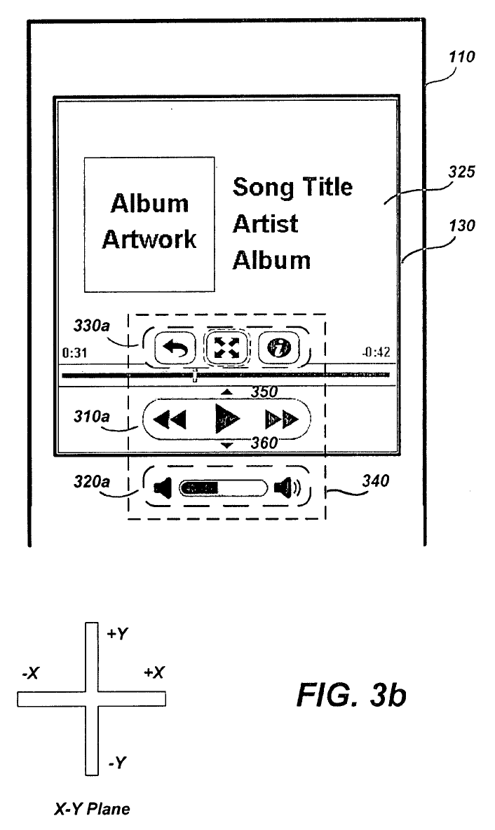

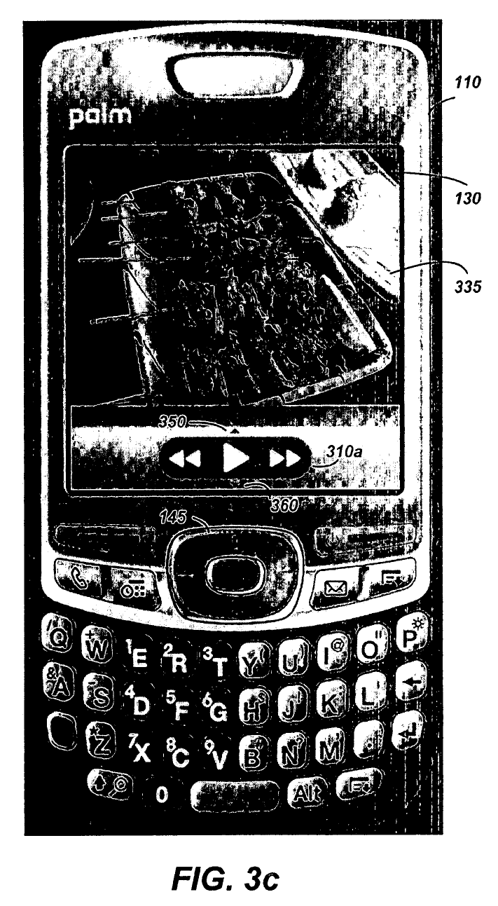

FIGS. 3a to 3c illustrates one embodiment of toolbar configuration for a mobile computing device. In the illustrated embodiment, three example toolbars 310a, 320a, 330b are illustrated. The illustrated example toolbars 310a, 320a, 330b are part of a toolbar set can be retrieved by the toolbar manager 228 to associate with a media application when the media application is executed by the processor 220 of the mobile computing device 110. Also illustrated are focus patterns 310b, 320b, 330b available through a navigation mechanism 145 corresponding to each toolbar 310a, 320a, 330a. The focus patterns 310b, 320b, 330b are illustrative of actions that can be taken based on how a user interacts with the navigation mechanism 145.

By way of example, the first toolbar 310 has three functions that are illustrated through the corresponding focus pattern 310b, 320b, 330b associated with a navigation mechanism: (1) play, which is activated by depressing (or triggering) a center switch within the navigation mechanism 145 (e.g., in a 5-way navigation mechanism) of the mobile computing device 110; (2) reverse, which is activated by depressing and holding a left portion of a navigation mechanism 145; and (3) forward, which is activated by depressing and holding a right portion of a navigation mechanism 145. In an alternate embodiment, depressing and immediately releasing the left portion or right portion of the navigation mechanism 145 may also function to skip tracks back or forward, respectively, rather than scan reverse and forward. In addition, it is noted that the arrows can represent that the movement can be gradual and may also reflect other physics properties such as speed, e.g., the longer the switch is depressed in a particular direction the faster the action (reverse or forward) in that direction, and mass, e.g., stopping an “bouncing” off the edge of screen 130 when an end of the toolbar is reached.

The second toolbar 320a has a single function that is illustrated through the corresponding focus pattern 320b associated with a navigation mechanism 145. This function is volume control and is controlled through depressing and holding a left portion of a navigation mechanism 145, e.g., to lower volume, or depressing and holding a right portion of a navigation mechanism 145, e.g., to raise volume. In an alternative embodiment, depressing and immediately releasing the left portion or the right portion of the navigation mechanism 145 may decrement or increment, respectively, the volume by a pre-defined amount (or level or value).

The third toolbar 330a has three separate discrete functions that are illustrated through the corresponding focus pattern 330b associated with the navigation mechanism 145. The functions in this toolbar 330a are selected by depressing and immediately releasing the left or the right portion of the navigation mechanism 145 once to make the selection and depressing and releasing the center portion of the navigation mechanism 145 to trigger the selection.

It is noted that although the navigation mechanism 145 and its operation is illustrated and described in the context of a mechanical structure on the mobile computing device 110, the principles for the navigation mechanism may be applied to, for example, an electromechanical navigation mechanism, a touch sensitive navigation mechanism, and an on-screen navigation mechanism. An example of the latter navigation mechanism is a navigation mechanism that is rendered as a user interface on a screen 130 and may be illustrated similar to the mechanical navigation mechanism. Moreover, when the screen 130 is touch oriented (and may incorporate a feedback mechanism), actions taken with the user interface translated to actions similar to the mechanical configuration.

The toolbar set 310a, 320a, 330a in FIG. 3a is illustrated through the example configurations in FIGS. 3b and 3c. In particular, a media application is executed by the processor 220 of the mobile computing device 110. A user interface 325 of the media application is displayed on the screen 130 of the device 110. At the time of execution, the processor 220 is configured to communicate with the toolbar manager 228 to retrieve a toolbar set for the application.

In FIG. 3b, a toolbar set 340 is shown with the first toolbar 310a displayed on top of the application user interface 325. The second and third toolbars 320a, 330a are not displayed to on the screen, but are retrievable through triggering of the up or down scroll arrows 350, 360. When the up or down arrows are triggered, the corresponding toolbar in that location is displayed and the other two toolbars are hidden from view. For example, is the up 350 arrow is triggered through depressing and releasing the upper portion of the navigation switch 145 the second toolbar 320a is displayed (and can be interacted with) and the other two toolbars 310a, 330a are now out of view. The other two toolbars 310a, 330a can be shown by triggering the down arrow button 360 until the particularly desired toolbar 310a or 330a is in view. FIG. 3c illustrates another embodiment of a mobile computing device 110 with the first toolbar 3110a overlaid on the user interface 335 of a photo applications.

As noted previously, in one embodiment, one toolbar would be visible on the screen 130 at any particular time. In such embodiments there is a visual indication that additional toolbars would be available from the top or the bottom, for example, the up or down arrows 350, 360. When the user reaches the top or the bottom toolbar of the set, the system may be configured to provide a different indicator signifying reaching the end of the set, for example, remove the indicator in that direction or show a kind of inertial bounce animation.

In illustrated example of the toolbar for the media player there are three toolbars. However, the number of toolbars can be extended infinitely along y-axis in an x-y plane depending on which features the developer seeks to add. Users would select among the toolbars using the visual indicators, e.g., up or down arrows 350, 360, in conjunction with the appropriate triggering mechanism, e.g., the portion of the navigation mechanism corresponding to a up or down direction, to bring the particular toolbars into view. The toolbar brought into view on the screen 130 is considered the active toolbar from which functions may be further selected and triggered.

It is noted that in some embodiments of a toolbar, for example, for audio/video transport controls and the volume control there may be a “focus” on the entire toolbar. In this context, the left and right movement on the navigation mechanisms 145, e.g., 5-way switch, immediately triggers (or executes) an action. In some embodiments, toolbars can have individual icons with focus, like the top toolbar.

There may be instances when the user may need to navigate to a particular action and thereafter trigger execution through the trigger button of the navigation mechanism 145, for example, a center portion of a five way navigation switch. This can be illustrated with the second third toolbar 330a in FIG. 3b in which the left and right would change focus among the available function icons and would be triggered (executed) through an activation switch, e.g., the center switch in a 5-way navigation switch. Note that although the third toolbar 330 is illustrated with three icons corresponding to three functions, the icons and corresponding functions could be extended infinitely along an x-axis in an x-y plane. Although the screen 130 may be unable to accommodate display of every icon and corresponding function, as with the toolbars that are out of view, the icons and functions may be out of view but made available through a scroll left and right using the those portions of the navigation mechanism 145 corresponding to left and right movement. Further, the icons may be aligned to end on each edge of the x-axis or may be continuously wrapped (e.g., the “−x” edge meets the “+x” edge of the x-axis).

Continuing with FIG. 3b, the first toolbar 310a illustrates the media transport controls. In this example toolbar 310a, selecting (or clicking) the corresponding left and right directions on the navigation mechanism 145 would immediately skip to the previous or next track, e.g., for an audio application. Depressing and holding the corresponding left or right portions relative to the navigation mechanisms scans through the current (playing) track. The selection trigger of the navigation mechanism 145, e.g., the center switch of the 5-way navigation ring, would play/pause the current track. In the second example toolbar 320a, selecting and holding the left or right portions relative to the navigation mechanism would immediately adjust the indicator and the actual playback volume.

In one embodiment, when changing toolbars, focus initially is on the center of the toolbar (where applicable) and corresponding position with respect to the navigation mechanism 145, e.g., the center switch of a 5-way navigation switch. Further, the toolbar manager 228 can be configured to handle multiple toolbars that can have individually focused buttons and that could retain a prior user selection for each toolbar accessed and previously used by the user.

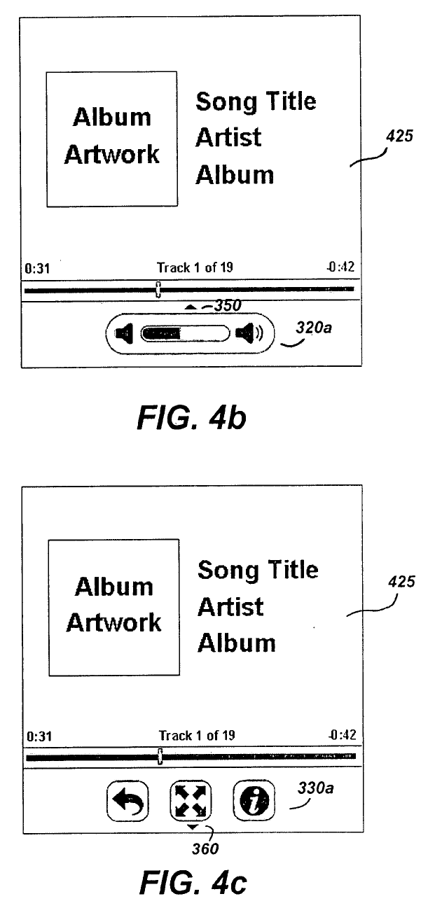

Referring next to FIGS. 4a to 4c, further illustrate the example toolbar set configuration for another an audio-type media application executing on the processor 220 of the computing device 110. The figures illustrate the user interface views 425 as displayed on the screen 130 of the device 110. In FIG. 4a, the user interface of the audio-type media application illustrates album artwork along with song title, artist and album name details. In one embodiment, the audio-type application interfaces with the toolbar manager 228 to call in a toolbar set, e.g., 350, to provide the user with the toolbars 310a, 320a, 330a to control the media type application.

When first called the toolbar initially displayed is the first toolbar 310a, that corresponds to play options for the audio-type application. Specifically, in this example, the user is playing the user tracks when the toolbar set 350 is called and the first toolbar 310a is displayed over the user interface 425. Making a left or right selection through the navigation mechanism 145 that is mapped to the toolbar functions, the user would skip to previous or next tracks. Depressing and holding either the left or right portions of the navigation mechanism would allow the user to could scan within the current track. Depressing and immediately releasing a selection portion of the navigation mechanism, e.g., the center switch on a 5-way navigation mechanism, would result a pause of the current track (and pressing and releasing that same switch again would cause the play to resume).

FIG. 4b illustrates additional features of the toolbar set. With respect to basic media playback controls, in this example, as the user is playing an audio track, the media toolbar controller may be scrolled (e.g., through triggering the bottom arrow 360) to the bottom toolbar. In this scenario, triggering (or “clicking”) left or right on the navigation mechanism 145 simultaneously adjusts the audio volume of the device 110 and the visual indicator of the toolbar 320a. In one embodiment, after a pre-determined period of user inactivity, e.g., 3 seconds, the media toolbar controller scrolls back to the center (or primary) toolbar 310a that shows the playback controls.

Continuing with the example, in FIG. 4c additional functions associated with the toolbar set are illustrated. Specifically, the Figure continues to illustrate playing of an audio track in the audio-type media application 435. In this example, the media toolbar is scrolled (e.g., triggering the up arrow 350) to the top toolbar 330a. Thereafter, the navigation mechanism 145 can be triggered (or “clicking”) left or right to shift focus to the next or previous button in this toolbar 330a. Once selected, the user would trigger (or “click”) the activation mechanism on the navigation mechanism 145, e.g., the center button on a 5-way navigation switch. Again, it is noted that although in this example there are three buttons shown, the design could accommodate many more buttons that may scroll off screen left and right. In such configurations, the buttons could either wrap infinitely, or they could have a start and an end.

As for the buttons in the top toolbar 330a, in this example, the buttons may correspond to functions as to various actions relative to the current audio track. For example, the user could zoom the album artwork to full screen, the user could get file info on the current track, or the user could return to the file browser. As with the bottom toolbar, after a pre-determined period of user inactivity, e.g., 3 seconds, the media toolbar controller scrolls back to the center (or primary) toolbar 310a that shows the playback controls.

It is noted that still other embodiments, the toolbar set can be configured to be removed from view after a predetermined time, e.g., 10 seconds. In such configurations, the device 110 system may store the toolbar set 340 in memory 216 as long as the application 425 is executing. When the user triggers an action on the navigation mechanism 145 (or some other trigger activity such as depressing and releasing a key on a keypad), the toolbar set is brought back into view, for example, with the primary toolbar 310a first showing.

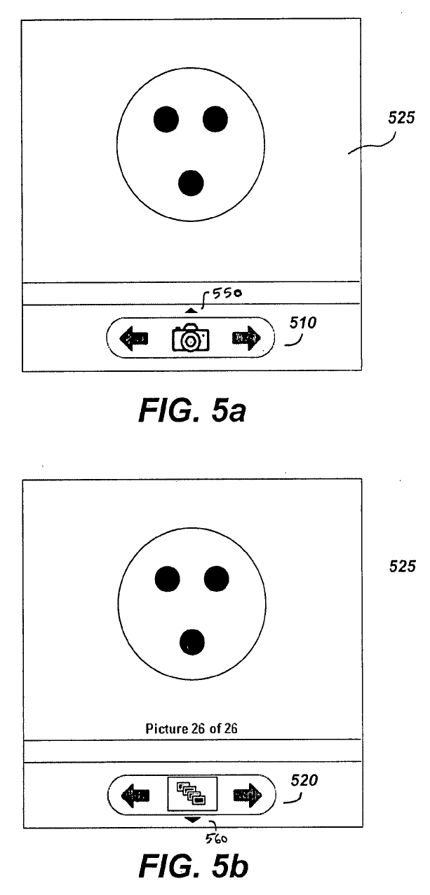

Referring next to another example of a toolbar set, FIGS. 5a to 5b illustrate an example toolbar configuration for a second media application, a camera application, executing on the computing device 110. In this example, a user interface 525 of a camera application is illustrated in which the camera application is executed by the processor 220 of the mobile computing device 110. Upon execution the application interfaces with the system toolbar manager 228 to retrieve a toolbar set for the application. This toolbar set includes two toolbars 510, 520. FIG. 5c illustrates the first toolbar 510, which is the primary toolbar to take a photo. In the primary toolbar 510 the camera icon button (i.e., center button) is pre-selected and immediately triggerable through the triggering mechanism on the navigation mechanism 145. When the center button is triggered, e.g., through the navigation mechanism, the picture is taken. Triggering the left and right arrows on the toolbar 510 would cause the application to allow the camera to zoom in or zoom out.

Next, by triggering the up arrow about the toolbar the user would navigate to the second toolbar 520 in the toolbar set. The second toolbar is for the camera application operating in a playback mode. When this toolbar 520 is selected, the center icon button is pre-selected and when triggered gives a view of picture thumbnails, e.g., of previously taken and stored pictures. When triggered, the left and right arrows navigate among recent pictures the user has taken. The down arrow can return the user to the primary (or first) toolbar 510 and back to the image capture mode.

It is noted that additional toolbars can be incorporated into the toolbar set. For example, the toolbar manager 228 could include a toolbar that provides additional options for that particular photo, like the option to delete the image, rotate the image, or transmit via a communication medium such as electronic mail, short message service, or Bluetooth.

The toolbars and toolbar sets as described have been articulated as system managed toolbars and functions. Such configurations offload the application from having to be integrated with such toolbars and instead allow the application to make system call to retrieve and integrate in with the execution of the application. This helps save application development time and reduces application size from removing tasks associated from having to build in such toolbars. Moreover, it beneficially allows for consistent look and feel of the toolbar across multiple applications.

Nevertheless, the toolbars can be built into the application also and still maintain additional benefits. Whether the toolbar is at the system level or build in, another benefit of the toolbars and toolbar sets is that the a number of toolbars can be accesses and immediately interacted with through the combination of the toolbars and the navigation mechanisms that a user interacts with in order to control actions within the toolbars. By linking toolbars together within a set and allowing traversal between them, toolbars are extendable to reach more functions quickly and efficiently. The user beneficially has access to more functions that are available than through conventional systems. Thus, user productivity can be significantly increased and operation and access to functions is made easier.

As disclosed, the extendable toolbar sets also provide advantages for small form factor mobile computing devices such as smartphones and other mobile communicators. These devices often lack the surface area for complex arrangements of buttons, keys and switches. By using the navigation mechanism such as a 5-way navigation mechanism (i.e., a center switch surrounded by four switches around it—one each on a +x-axis, a −x-axis, a +y-axis, and a −y-axis) the ranges of functions accessible through such switch can increase many-fold without a need for additional keys or buttons on the device.

It is noted that some portions of above description describe the embodiments of the invention in terms of algorithmic descriptions and representations of operations on information, for example, interfacing with the toolbar manager 228, displaying the toolbar set, navigating between buttons within the toolbar and navigating between toolbars. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an extendable toolbar for navigation and execution of operations through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A navigation and execution mechanism for a computing device comprising:
a navigation interface, the navigation mechanism having a center selectable switch bounded by a first and a second selectable switches opposite each other and a third and a fourth selectable switches opposite each other and adjacent to the first and the second selectable switches;
a toolbar displayed on a screen of the computing device in response to execution of an application within the computing device, the toolbar configured to display a set of operations corresponding to the application, the toolbar further configured to execute a first operation in response to triggering the center selectable switch, a second operation in response to triggering the first selectable switch, a third operation in response to triggering the second selectable switch.

2. The navigation and execution system of claim 1, further comprising a second toolbar having a second set of triggerable operations, the second toolbar displayed in response to triggering the third selectable switch when the toolbar is displayed, from the second set of triggerable operations the second toolbar further configured to execute a first operation in response to triggering the center selectable switch, a second operation in response to triggering the first selectable switch, and a third operation in response to triggering the second selectable switch.

3. The navigation and execution system of claim 2, further comprising a third toolbar having a third set of triggerable operations, the third toolbar displayed in response to triggering the fourth selectable switch when the toolbar is displayed, from the third set of triggerable operations the third toolbar further configured to execute a first operation in response to triggering the center selectable switch, a second operation in response to triggering the first selectable switch, a third operation in response to triggering the second selectable switch.

4. The navigation and execution system of claims 3, wherein the control parameters and a template for the toolbar are stored in a system database and retrieved by the application further in response to execution of the application.

5. The navigation and execution system of claim 4, wherein the application comprises one of an audio application, a video application, and an image viewer application.

6. The navigation and execution system of claim 4, wherein the application comprises one of a phone application.

7. The navigation and execution system of claim 3, wherein the first selectable switch is a left selectable switch, the second selectable switch is a right selectable switch, the third selectable switch is an up selectable switch and the fourth selectable switch is a down selectable switch.

8. A mobile computing device including a navigation and execution mechanism, the mobile computing device comprising:
a navigation interface, the navigation mechanism having a center selectable switch bounded by a first and a second selectable switches opposite each other and a third and a fourth selectable switches opposite each other and adjacent to the first and the second selectable switches;
a toolbar manager configured to store a plurality of toolbars for use with a plurality of applications, each toolbar displayable on a screen of the computing device in response to execution of an application within the computing device, each toolbar configured to display a set of operations corresponding to the application, at least one toolbar further configured to execute a first operation in response to triggering the center selectable switch, a second operation in response to triggering the first selectable switch, a third operation in response to triggering the second selectable switch.

9. The mobile computing system of claim 8, further comprising a second toolbar having a second set of triggerable operations, the second toolbar displayed in response to triggering the third selectable switch when the toolbar is displayed, from the second set of triggerable operations the second toolbar further configured to execute a first operation in response to triggering the center selectable switch, a second operation in response to triggering the first selectable switch, and a third operation in response to triggering the second selectable switch.

10. The mobile computing system of claim 9, further comprising a third toolbar having a third set of triggerable operations, the third toolbar displayed in response to triggering the fourth selectable switch when the toolbar is displayed, from the third set of triggerable operations the third toolbar further configured to execute a first operation in response to triggering the center selectable switch, a second operation in response to triggering the first selectable switch, a third operation in response to triggering the second selectable switch.

11. The mobile computing system of claim 8, wherein the first selectable switch is a left selectable switch, the second selectable switch is a right selectable switch, the third selectable switch is an up selectable switch and the fourth selectable switch is a down selectable switch.

12. The mobile computing system of claim 11, wherein the application comprises one of an audio application, a video application, and an image viewer application.

13. The mobile computing system of claim 11, wherein the application comprises one of a phone application.

14. A computer readable medium storing instructions thereon, the instructions when executed by a processor cause the processor to:
execute an application;
retrieve a toolbar set corresponding to the application, the toolbar set comprising a plurality of discrete toolbars;
display for view the a primary toolbar of the plurality of discrete toolbars, the remainder of the plurality of toolbars initially hidden from view;
receive a trigger signal corresponding to display of a second toolbar; and
remove the primary toolbar from view and display for view the second toolbar of the plurality of toolbars in response to the received trigger signal.

15. The computer readable medium of claim 14, further comprising instructions that cause the processor to
receive a trigger signal corresponding to display of the primary toolbar; and
remove the second toolbar from view and display for view the primary toolbar in response to the received trigger signal.

16. The computer readable medium of claim 15, wherein the received trigger signal corresponds to trigger of a switch along a positive y-axis in an x-y plane.

17. The computer readable medium of claim 14, wherein the received trigger signal corresponds to trigger of a switch along a negative y-axis in an x-y plane.

18. The computer readable medium of claim 14, wherein the view of at least one toolbar of the plurality of toolbars displayed includes at least one function hidden from view on the screen and wherein the instructions further comprise instructions that cause the processor to receive a trigger signal to access the at least one function hidden from the view.

19. The computer readable medium of claim 18, wherein the received trigger signal corresponds to trigger of a switch along a positive x-axis in an x-y plane.

20. The computer readable medium of claim 14, wherein the received trigger signal corresponds to trigger of a switch along a negative x-axis in an x-y plane.
